(19) United States
(12) Patent Application Publication
(10) Pub. No.: US 2005/0071830 A1
(43) Pub. Date: Mar. 31, 2005

(54) Method and system for processing a sequence of instructions

(75) Inventor: Gil Naveh, Modi'in (IL)

Correspondence Address: HAYNES AND BOONE, LLP, 901 MAIN STREET, SUITE 3100, DALLAS, TX, 75202, US

(73) Assignee: StarCore, LLC, Austin, TX (US)

(21) Appl. No.: 10/675,640

(22) Filed: Sep. 30, 2003

(51) Int. Cl. G06F 9/40

(52) U.S. Cl. 717/151; 712/215

(57) ABSTRACT

An information handling system processes a sequence of instructions that includes first and second instructions. Each of the first and second instructions is processable in a sequence of stages that includes first and second execution stages. The first instruction's second execution stage is processable substantially concurrent with processing the second instruction's first execution stage. The first instruction is executed during its second execution stage. The second instruction is executed during a selected one of its first and second execution stages. A computer program product includes apparatus from which a computer program is accessible by an information handling system. The computer program is processable by the information handling system for causing the information handling system to assemble the sequence of instructions. The assembling includes: (a) assembling the first instruction for execution during its second execution stage; and (b) assembling the second instruction for execution during a selected one of its first and second execution stages.

### BACKGROUND

The disclosures herein relate generally to information handling systems and in particular to a method and system for processing a sequence of instructions.

By processing instructions in a sequence of interlocked pipeline stages, an information handling system concurrently processes various stages of multiple instructions. A particular sequence of instructions could result in a read/write conflict that delays (or stalls) operation of the system, especially if an instruction's various stages include multiple execution stages. It is preferable for the system to avoid or reduce such delays.

A need has arisen for a method and system for processing a sequence of instructions, in which various shortcomings of previous techniques are overcome. For example, a need has arisen for a method and system for processing a sequence of instructions, in which delays are avoided or reduced.

### SUMMARY

In one embodiment, an information handling system processes a sequence of instructions that includes first and second instructions. Each of the first and second instructions is processable in a sequence of stages that includes first and second execution stages. The first instruction's second execution stage is processable substantially concurrent with processing the second instruction's first execution stage. The first instruction is executed during its second execution stage. The second instruction is executed during a selected one of its first and second execution stages.

In another embodiment, a computer program product includes apparatus from which a computer program is accessible by an information handling system. The computer program is processable by the information handling system for causing the information handling system to assemble the sequence of instructions. The assembling includes: (a) assembling the first instruction for execution during its second execution stage; and (b) assembling the second instruction for execution during a selected one of its first and second execution stages.

A principal advantage of these embodiments is that various shortcomings of previous techniques are overcome, and delays are avoided or reduced.

### BRIEF DESCRIPTION OF THE DRAWING

FIG. 1 is a block diagram of an example system according to the illustrative embodiment.

FIG. 2 is a block diagram of a program sequencer unit of the system of FIG. 1.

FIG. 3 is a first example timing diagram that depicts a sequence of instructions, which are processed by the system of FIG. 1.

FIG. 4 is a second example timing diagram that depicts the sequence of instructions.

FIG. 5 is a third example timing diagram that depicts the sequence of instructions.

FIG. 6 is a fourth example timing diagram that depicts the sequence of instructions.

FIG. 7 is a fifth example timing diagram that depicts the sequence of instructions.

FIG. 8 is a flowchart of preferable operation of the system of FIG. 1, in accordance with FIG. 7.

### DETAILED DESCRIPTION

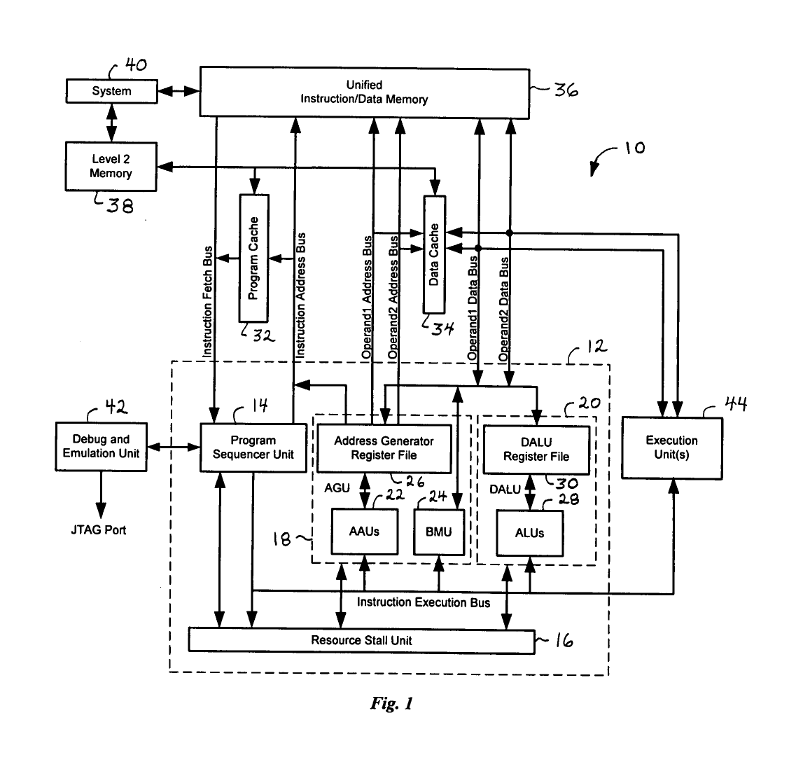

FIG. 1 is a block diagram of an example system, indicated generally at 10, for handling information (e.g., instructions, data, signals), according to the illustrative embodiment. In the illustrative embodiment, the system 10 is formed by various electronic circuitry components. Accordingly, the system 10 includes various units, registers, buffers, memories, and other components, which are (a) coupled to one another through buses, (b) formed by integrated circuitry in one or more semiconductor chips, and (c) encapsulated in one or more packages.

As shown in FIG. 1, the system 10 includes a core unit, indicated by a dashed enclosure 12, for performing various operations as discussed hereinbelow in connection with FIGS. 1-8. The core unit 12 includes: (a) a program sequencer unit 14; (b) a resource stall unit 16; (c) an address generation unit (“AGU”), indicated by a dashed enclosure 18; and (d) a data arithmetic logic unit (“DALU”), indicated by a dashed enclosure 20. The AGU includes arithmetic address units (“AAUs”) 22, a bit mask unit (“BMU”) 24, and an address generator register file 26. The DALU includes arithmetic logic units (“ALUs”) 28 and a DALU register file 30. The program sequencer unit 14, resource stall unit 16, AGU 18 (including its various units and files), and DALU 20 (including its various units and files) are interconnected as shown in FIG. 1.

Further, as shown in FIG. 1, the core unit 12 is connected to a program cache 32, a data cache 34, and a unified instruction/data memory 36. The program cache 32 and data cache 34 are connected to a level-2 memory 38. The memories 36 and 38 are connected to other components 40 of the system 10.

Also, a debug & emulation unit 42 is coupled between the program sequencer unit 14 and a Joint Test Action Group (“JTAG”) port for debugging and emulating various operations of the system 10, in accordance with conventional JTAG techniques. Moreover, as shown in FIG. 1, one or more additional execution unit(s) 44 is/are optionally connected to the core unit 12, data cache 34, and memory 36.

For performing its various operations, the system 10 includes various other interconnections, components (e.g., memory management circuitry) and other details that, for clarity, are not expressly shown in FIG. 1. For example, the various address buses communicate suitable control signals, in addition to address signals. Likewise, the various data buses communicate suitable control signals, in addition to data signals.

The resource stall unit 16 is responsible for controlling an interlocked pipeline of the system 10. In response to information from an instruction execution bus, the resource stall unit 16 stores information about the status (or state) of various components of the core unit 12. In response to such status (or state) information, the resource stall unit 16 resolves conflicts and hazards in the pipeline by outputting suitable information to the program sequencer unit 14, AGU 18, DALU 20, and various other components of the system 10.

For example, in response to information from the resource stall unit 16, the program sequencer unit 14 reads and dispatches instructions in order of their programmed sequence. For reading instructions, the program sequencer unit 14 outputs suitable instruction addresses to the program cache 32 and memory 36 via a 32-bit instruction address bus. Similarly, in response to information from the resource stall unit 16 and AAUs 22, the address generator register file 26 outputs suitable instruction addresses to the program cache 32 and memory 36 via the instruction address bus, as for example in response to various types of change of flow (“COF”) instructions that loop, interrupt, or otherwise branch or jump away from the program sequencer unit 14 sequence of instruction addresses. Such addresses (received via the instruction address bus from either the program sequencer unit 14 or the address generator register file 26) indicate suitable memory locations that store a sequence of instructions for execution by the system 10 (“addressed instructions”).

Accordingly, in response to such addresses: (a) if the addresses are then-currently indexed in the program cache 32, the program cache 32 outputs the addressed instructions to the program sequencer unit 14 via a 128-bit instruction fetch bus; or (b) otherwise, the memory 36 outputs the addressed instructions to the program sequencer unit 14 via the instruction fetch bus. The program sequencer unit 14 receives and stores such instructions. In response to such fetched instructions, and in response to information received from the resource stall unit 16, the program sequencer unit 14 outputs (or dispatches) such instructions at suitable moments via an instruction execution bus to the resource stall unit 16, AAUs 22, BMU 22, ALUs 28, and execution unit(s) 44. The program sequencer unit 14 also includes circuitry for performing operations in support of exception processing.

The system 10 includes multiple units for executing instructions, namely the AAUs 22, BMU 24, ALUs 28, and execution unit(s) 44. In response to status (or state) information from the resource stall unit 16, such units execute one or more instructions, according to the various types of instructions (e.g., according to an instruction's particular type of operation). For example, using integer arithmetic, the AAUs 22 execute the address calculation operations of various instructions, such as COF instructions. The BMU 24 executes various instructions for shifting and masking bits in operands. The ALUs 28 execute various instructions for performing arithmetic and logical operations (e.g., numeric addition, subtraction, multiplication, and division) on operands. The execution unit(s) 44 execute various instructions for performing application-specific operations on operands in an accelerated manner.

At suitable moments, the AAUs 22 communicate with the address generator register file 26 (and vice versa) by receiving their source operand information from (and outputting their resultant destination operand information for storage to) the address generator register file 26. Likewise, at suitable moments, the ALUs 28 communicate with the DALU register file 30 (and vice versa) by receiving their source operand information from (and outputting their resultant destination operand information for storage to) the DALU register file 30.

Similarly, at suitable moments, the BMU 24, address generator register file 26, DALU register file 30, and execution unit(s) 44 communicate with the data cache 34 and/or memory 36 (and vice versa) by receiving their source operand information from (and outputting their resultant destination operand information for storage to) the data cache 34 and/or memory 36 via 64-bit operand1 and operand2 data buses. The addresses of such operand information are output from the address generator register file 26 via respective 32-bit operand1 and operand2 address buses, in response to information from the AAUs 22.

The program cache 32 and data cache 34 receive and store copies of selected information from the level-2 memory 38. In comparison to the level-2 memory 38, the program cache 32 and data cache 34 are relatively small memories with higher speed. The information in program cache 32 and data cache 34 is modifiable. Accordingly, at suitable moments, the system 10 copies such modified information from the program cache 32 and data cache 34 back to an associated entry in the level-2 memory 38 for storage, so that coherency of such modified information is maintained.

Similarly, via the other components 40 of the system 10, the level-2 memory 38 receives and stores copies of selected information from the memory 36. In comparison to the memory 36, the level-2 memory 38 is a relatively small memory with higher speed. The information in the level-2 memory 38 is modifiable, as for example when the system 10 copies modified information from the program cache 32 and data cache 34 back to an associated portion of the level-2 memory 38. Accordingly, at suitable moments, the system 10 copies such modified information from the level-2 memory 38 back to an associated entry in the memory 36 for storage, so that coherency of such modified information is maintained.

The system 10 achieves high performance by processing multiple instructions simultaneously at various ones of the AAUs 22, BMU 24, ALUs 28, and execution unit(s) 44. For example, the system 10 processes each instruction by a sequence of interlocked pipeline stages. Accordingly, the system 10 processes each stage of a particular instruction in parallel with various stages of other instructions.

In general, the system 10 operates with one machine cycle (“cycle”) per stage (e.g., any stage's duration is a single machine cycle). However, some instructions (e.g., ACS, MAC, MPY and SAD, as described in Table 1) may require multiple machine cycles for execution (i.e., such instructions are executable in only multiple machine cycles of the system 10). Also, a memory access (e.g., instruction fetch or operand load) may require several machine cycles of the system 10. In response to conflicts (e.g., read/write conflicts) between instructions, the resource stall unit 16 selectively introduces one or more delays (or stalls) in finishing a particular instruction's execution stage.

TABLE 1
Instructions Having Two Machine Cycles for Execution

| Instruction & | |
|---|---|
| Example Assembly Syntax | Example Operation (performed by the DALU 20) |
| Add compare select | Performs four (4) operations of addition/subtraction between |
| (“ACS”) | a selection of high portion (“HP”) and low portion (“LP”) |
| ACS2 Da.X, Db.Y, Dc, Dn | contents of operand registers (Da, Db, Dc, Dn). Compares |
| | and finds the maximum of the results of the first two |
| | operations, and writes the maximum result to the HP of an |
| | operand register (Dn.H). Compares and finds the maximum |
| | of the results of the last two operations, and writes the |
| | maximum result to the LP of the operand register (Dn.L). If |
| | the first operation result is greater than the second operation |
| | result, bit 32 in the destination operand register (Dn[32]) is |
| | cleared; otherwise, the bit is set. If the third operation result |
| | is greater than the fourth operation result, bit 33 in the |
| | destination operand register (Dn[33]) is cleared; otherwise, |
| | the bit is set. The two HP and LP of the destination are |
| | limited to 16-bits. In case of overflow, the results are |
| | saturated to 16-bits maximum or minimum values. The |
| | extension byte of the result is undefined. |
| Multiply-accumulate | Performs signed fractional multiplication of two 16-bit |
| signed fractions (“MAC”) | signed operands (Da.H/L and Db.H/L). Then adds or |
| MAC Da, Db, Dn | subtracts the product to or from a destination operand register |
| | (Dn). One operand is the HP or the LP of an operand |
| | register. The other operand is the HP or the LP of an operand |
| | register or an immediate 16-bit signed data. |
| Multiply signed fractions | Performs signed fractional multiplication of the high or low |
| (“MPY”) | portions of two operand registers (Da, Db) and stores the |
| MPY Da, Db, Dn | product in a destination operand register (Dn). |
| Sum of absolute byte | Performs a 32-bit subtraction of source register Da from Db |
| differences (“SAD”) | with the borrow disabled between bits 7 and 8, 15 and 16, |
| SAD4 Da, Db, Dn | and 23 and 24, so that the four bytes of each register are |
| | unsigned subtracted separately. The absolute value of each |
| | subtraction is added to the LP of the destination register Dn. |
| | The extension byte and the HP of the result are zero |
| | extended. |

In the illustrative embodiment, the system 10 processes an instruction in a sequence of ten interlocked pipeline stages, as described in Table 2, so that each instruction is processed in the same sequence of stages. During each pipeline stage, the system 10 prepares the instruction for its next stage. After the system 10 initiates an instruction's processing, the system 10 initiates the immediately subsequent instruction's processing at a later time (e.g., one machine cycle later). In that manner, the system 10 concurrently processes various stages of multiple instructions.

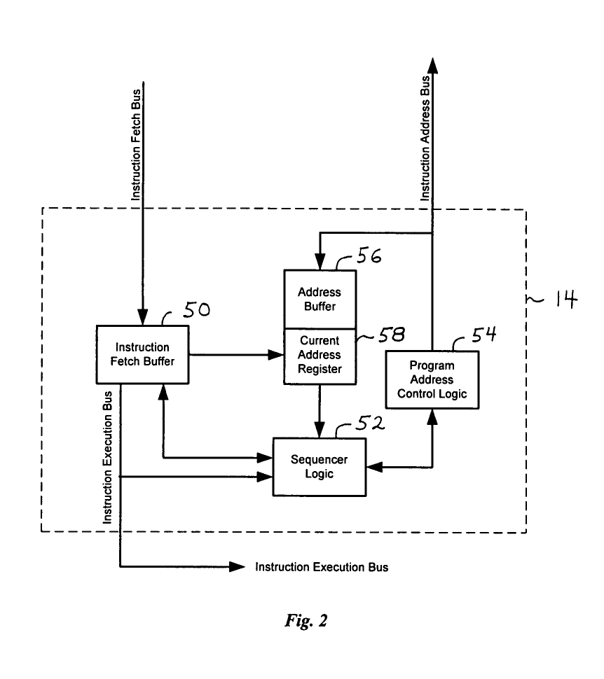

The multi-stage pipeline of the system 10 includes multiple execution stages. For example, in the illustrative embodiment as described in Table 2, the pipeline includes a first execution stage (E-stage) and a second execution stage (M-stage). In an alternative embodiment, the pipeline includes first and second execution stages, plus at least one additional execution stage. In such an alternative embodiment, the respective operations of the multiple execution stages are suitably established, according to the various objectives of the system 10, so that one or more of the E-stage or M-stage operations (which are described in Table 2 and elsewhere hereinbelow in connection with FIGS. 2-8) is/are performed instead (or additionally) by a suitable one or more of the multiple execution stages.

For example, in a first alternative embodiment, the additional execution stage(s) precede(s) the illustrative embodiment's first execution stage, so that the additional execution stage(s) would be immediately preceded by the C-stage in Table 2 and would perform operations accordingly. In a second alternative embodiment, the additional execution stage(s) follow(s) the illustrative embodiment's second execution stage, so that the additional execution stage(s) would be immediately followed by the W-stage in Table 2 and would perform operations accordingly. In a third alternative embodiment, one or more of the additional execution stage(s) precede(s) the illustrative embodiment's first execution stage, and one or more of the additional execution stage(s) follow(s) the illustrative embodiment's second execution stage, so that: (a) at least one of the additional execution stage(s) would be immediately preceded by the C-stage in Table 2 and would perform operations accordingly; and (b) at least one of the additional execution stage(s) would be immediately followed by the W-stage in Table 2 and would perform operations accordingly. Thus, similar to the illustrative embodiment, such alternative embodiments likewise benefit from the techniques discussed hereinbelow (in connection with FIGS. 2-8), and such techniques are likewise applicable to such alternative embodiments.

TABLE 2
Pipeline Stages Overview

| Pipeline Stage | Symbol | Description |
|---|---|---|
| Program Address | P-stage | During this machine cycle, via the instruction address |
| | | bus, a suitable instruction address is output to the |
| | | program cache 32 and memory 36. |
| Read Memory | R-stage | During this machine cycle, in response to the instruction |
| | | address that was output during the P-stage, instructions |
| | | are accessed in the program cache 32 and/or memory 36, |
| | | and sixteen (16) sequential bytes of instructions are |
| | | output via the instruction fetch bus from the program |
| | | cache 32 and/or memory 36, according to whether the |
| | | instruction address is then-currently indexed in the |
| | | program cache 32. |
| Fetch | F-stage | During this machine cycle, via the instruction fetch bus, |
| | | the program sequencer unit 14 receives and stores the |
| | | sixteen (16) sequential bytes of instructions that were |
| | | output during the R-stage. |
| VLES Dispatch | V-stage | During this machine cycle, the program sequencer unit |
| | | 14 dispatches a variable length execution set (“VLES”) |
| | | instruction via the instruction execution bus to suitable |
| | | execution units (i.e., the AAUs 22, BMU 24, ALUs 28, |
| | | and execution unit(s) 44). If the instruction is a prefix |
| | | instruction, which modifies the manner in which the |
| | | system 10 processes subsequent instructions (e.g., if |
| | | subsequent instructions are part of an alternative |
| | | instruction set, which may be executed by execution |
| | | unit(s) 44 to perform application-specific operations), |
| | | the prefix instruction is decoded accordingly by the |
| | | program sequencer unit 14 during this machine cycle. |
| Decode | D-stage | During this machine cycle, the dispatched instruction is |
| | | decoded by the instruction's execution unit (i.e., the |
| | | execution unit that will execute the instruction). |
| Address generation | A-stage | During this machine cycle, via the operand1 and |
| | | operand2 address buses, the AGU 18 (from its address |
| | | generator register file 26) outputs addresses of source |
| | | operand information and destination operand |
| | | information to the data cache 34 and memory 36. |
| Memory aCcess | C-stage | During this machine cycle, in response to the addresses |
| | | that were output during the A-stage, source operand |
| | | information is accessed in the data cache 34 and/or |
| | | memory 36, and the source operand information is |
| | | output via the operand1 and operand2 data buses from |
| | | the data cache 34 and/or memory 36, according to |
| | | whether the source operand information's address is |
| | | then-currently indexed in the data cache 34. |
| Execution | E-stage | During this machine cycle, via the operand1 and |
| | | operand2 data buses, the instruction's execution unit |
| | | receives source operand information that was output |
| | | during the C-stage. Also, during this machine cycle, the |
| | | instruction's execution unit executes the instruction. |
| Mac | M-stage | During this machine cycle, if the instruction requires |
| | | two machine cycles for execution, the instruction's |
| | | execution unit finishes executing the instruction. |
| | | Conversely, if the instruction requires only a single |
| | | machine cycle for execution and is executed during the |
| | | E-stage, the system 10 prepares the instruction for its |
| | | W-stage, but otherwise performs no operation (“NOP”) |
| | | in response to the instruction during this machine cycle. |
| Write back | W-stage | During this machine cycle, via the operand1 and |
| | | operand2 data buses, the instruction's execution unit |
| | | outputs (or writes or stores) destination operand |
| | | information to the data cache 34 and/or memory 36, |
| | | according to whether the destination operand |
| | | information's address is then-currently indexed in the |
| | | data cache 34. |

FIG. 2 is a block diagram of the program sequencer unit 14. As shown in FIG. 2, the program sequencer unit 14 includes an instruction fetch buffer 50, a sequencer logic 52, a program address control logic 54, an address buffer 56, and a current address register 58. Such elements of the program sequencer unit 14 perform various operations as discussed hereinbelow in connection with FIGS. 2-8.

For performing its various operations, the program sequencer unit 14 includes various other interconnections (e.g., to the resource stall unit 16), components and other details that, for clarity, are not expressly shown in FIG. 2. For example, the program address control logic 54 is connected to the instruction address bus of FIG. 1 and performs the P-stage operations of the program sequencer unit 14. During a P-stage of an instruction, if the program address control logic 54 or AGU 18 outputs an instruction address in response to a COF instruction, the address buffer 56 receives and buffers (or stores) such instruction address, at least until such instruction address is received (as discussed hereinbelow) from the address buffer 56 by the current address register 58.

The instruction fetch buffer 50 is coupled between the instruction fetch bus of FIG. 1 and the instruction execution bus of FIG. 1. In response to the program address control logic 54 performing a P-stage operation: (a) during the immediately following machine cycle(s), a corresponding R-stage operation is performed; and (b) during the immediately following machine cycle(s) after the R-stage operation is performed, the instruction fetch buffer 50 performs a corresponding F-stage operation of the program sequencer unit 14. The instruction fetch buffer 50 receives and buffers up to sixty-four (64) bytes of instructions from the instruction fetch bus.

In the absence of contrary information from the AGU 18 (in the event of a COF instruction): (a) as the instruction fetch buffer 50 performs V-stages of one or more instructions, the current address register 58 increments its latched address by the number of dispatched instruction bytes (i.e., which may be an even number ranging from 2 to 16 bytes, because the instructions are VLES instructions), which the current address register 58 receives from the instruction fetch buffer 50; and (b) in so performing an instruction's V-stage, if the instruction is processed in response to a COF instruction, the current address register 58 receives and latches a next instruction address from the address buffer 56. After so receiving and latching the next instruction address from the address buffer 56, the current address register 58 increments if necessary to ensure that its latched address is associated with the instruction whose V-stage is being performed by the instruction fetch buffer 50.

The instruction fetch buffer 50 operates as a first-in first-out queue. In the illustrative embodiment, the system 10 coordinates F-stages and V-stages of instructions in a manner that generally avoids completely filling the instruction fetch buffer 50. Nevertheless, even if the instruction fetch buffer 50 is full, it ceases being full if it performs V-stages of at least sixteen (16) bytes of instructions. This is because, during such V-stages, the instruction fetch buffer 50 outputs such buffered instructions to the instruction execution bus.

In the absence of contrary information from the sequencer unit 52 (or the AGU 18 in the event of a COF instruction), the program address control logic 54 performs the P-stage operation by outputting an instruction address that is incremented from its most recently output instruction address. Such increment is sixteen (16) (i.e., the number of bytes received by the instruction fetch buffer 50 from the instruction fetch bus during an F-stage).

The current address register 58 outputs its latched instruction address to a sequencer logic 52. The sequencer logic 52 selectively outputs signals to the instruction fetch buffer 50 and program address control logic 54. Also, the sequencer logic 52 selectively receives signals from the instruction fetch buffer 50, program address control logic 54, and current address register 58. Various example operations of the program sequencer unit 14 are discussed hereinbelow.

The system 10 has an interlock pipeline architecture, such that a particular sequence of instructions could result in a read/write conflict that delays (or stalls) operation of the system 10. It is preferable for the system 10 to avoid or reduce such delay. According to one technique, an information handling system (e.g., computer workstation) processes assembly code (which is a computer program stored on a computer-readable medium apparatus) for causing the information handling system to assemble a software program into the sequence of binary executable instructions, where the assembly code is at least partly optimized (e.g., in a manner that selectively inserts NOP instructions and other types of instructions at suitable locations in the sequence), so that such stalls are less likely when the system 10 processes the sequence. For example, the assembly code is accessible by the information handling system from a computer-readable medium apparatus (e.g., hard disk, floppy diskette, compact disc, memory device, or network connection). According to another technique, the system 10 includes circuitry for processing the sequence in a manner that reduces a likelihood of such stalls during such processing, irrespective of whether the assembly code is optimized.

FIG. 3 is a first example timing diagram that depicts a sequence of three instructions n, n+1, and n+2 (where n in an integer), which are processed by the system 10. In the example of FIG. 3, each of the instructions is executable in a single machine cycle, so that the system 10 executes: (a) the instruction n during its E-stage cycle k+1 (where k is an integer); (b) the instruction n+1 during its E-stage cycle k+2; and (c) the instruction n+2 during its E-stage cycle k+3. As shown for each instruction in FIG. 3, the system 10 initiates: (a) the instruction's respective E-stage cycle in the next cycle after finishing the instruction's respective C-stage; and (b) the instruction's respective W-stage cycle in the next cycle after finishing the instruction's respective M-stage. In the example of FIG. 3: (a) each instruction is executable in a single machine cycle, so the system 10 does not execute the instruction during its respective M-stage; (b) the system 10 does not encounter a read/write conflict; and (c) operation of the system 10 is not stalled by execution of the instructions n, n+1, and n+2.

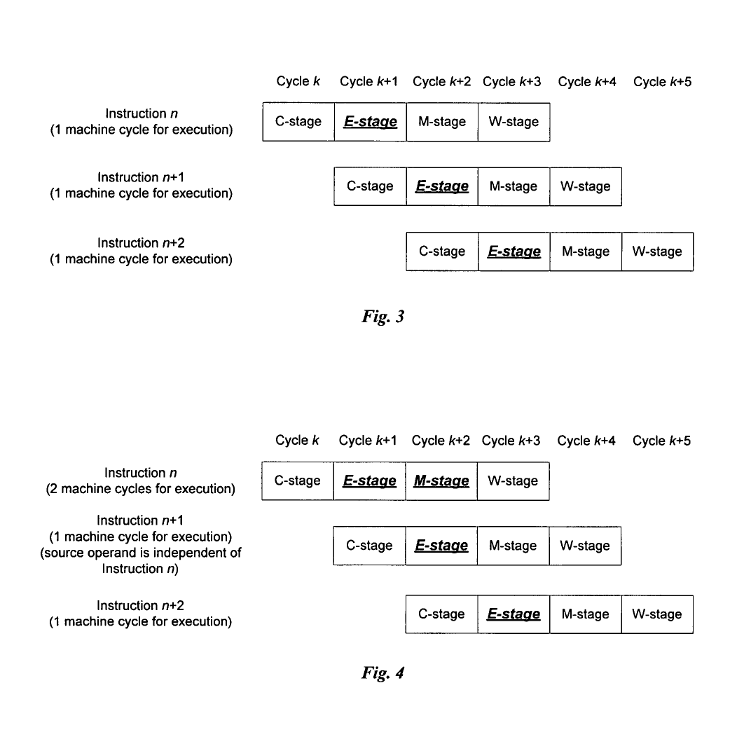

FIG. 4 is a second example timing diagram that depicts the instructions n, n+1, and n+2. In the example of FIG. 4: (a) each of the instructions n+1 and n+2 is executable in a single machine cycle, but the instruction n is executable in two machine cycles; and (b) the instruction n+1 is independent of its immediately preceding instruction n (e.g., the source operand(s) of the instruction n+1 is/are independent of the destination operand(s) of the instruction n). Accordingly, in FIG. 4, the system 10 executes: (a) the instruction n during its E-stage cycle k+1 and its M-stage cycle k+2; (b) the instruction n+1 during its E-stage cycle k+2; and (c) the instruction n+2 during its E-stage cycle k+3. In such a situation: (a) the system 10 does not encounter a read/write conflict; and (b) operation of the system 10 is not stalled by execution of the instructions n, n+1, and n+2.

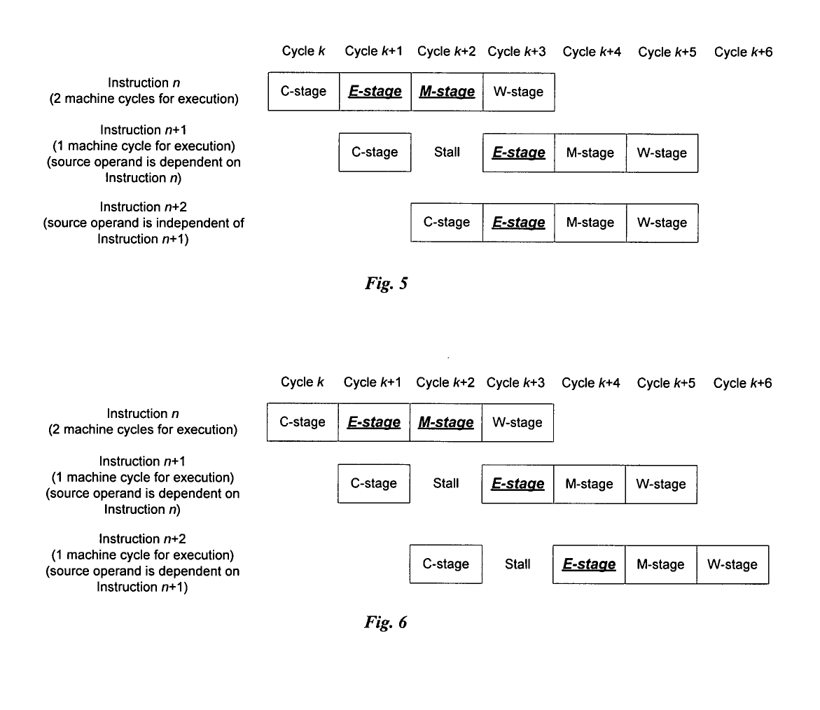

FIG. 5 is a third example timing diagram that depicts the instructions n, n+1, and n+2. In the example of FIG. 5: (a) each of the instructions n+1 and n+2 is executable in a single machine cycle, but the instruction n is executable in two machine cycles; (b) the instruction n+1 is dependent on its immediately preceding instruction n (e.g., the source operand(s) of the instruction n+1 is dependent on the destination operand(s) of the instruction n); and (c) the instruction n+2 is independent of its immediately preceding instruction n+1. Accordingly, in FIG. 5, the system 10 executes: (a) the instruction n during its E-stage cycle k+1 and its M-stage cycle k+2; (b) the instruction n+1 during its E-stage cycle k+3; and (c) if suitable execution resources are then-currently available, the instruction n+2 during its E-stage cycle k+3 (e.g., if suitable execution resources are then-currently available within the AAUs 22, BMU 24, ALUs 28, and/or execution unit(s) 44, according to the specified operations of the instruction n+2).

In such a situation: (a) the system 10 encounters a read/write conflict between the instructions n and n+1, because the instruction n+1 is dependent on its immediately preceding instruction n, and such instruction n is executable in two machine cycles; and (b) as a result, operation of the system 10 is stalled as it delays processing the E-stage of the instruction n+1 by one cycle (i.e., delayed from its originally scheduled cycle k+2 until the cycle k+3) to await the finish of the M-stage cycle k+2 of the instruction n. By comparison, for the instruction n+2 in the example of FIG. 5: (a) the system 10 does not encounter a read/write conflict between the instructions n+1 and n+2, because the instruction n+2 is independent of its immediately preceding instruction n+1; and (b) without additional delay, if suitable resources are then-currently scheduled to be available for concurrently processing the remaining stages of both instructions n+1 and n+2, the system 10 processes the E-stage of the instruction n+2 during its originally scheduled cycle k+3, substantially concurrent with processing the delayed E-stage of the instruction n+1 during the cycle k+3, so that operation of the system 10 ceases being delayed.

Conversely, if suitable resources are not then-currently scheduled to be available for concurrently processing the remaining stages of both instructions n+1 and n+2, operation of the system 10 remains delayed by one cycle, as the system 10 processes the E-stage of the instruction n+2 one cycle later (i.e., cycle k+4) than its originally scheduled cycle (i.e., cycle k+3), in order to await the finish of the E-stage cycle k+3 of the instruction n+1. In view of such delay in execution of the instruction n+1, and in view of the resulting potential delay in execution of the instruction n+2 if suitable resources are not then-currently scheduled to be available, operation of the system 10 in FIG. 5 is not preferred.

FIG. 6 is a fourth example timing diagram that depicts the instructions n, n+1, and n+2. Like FIG. 5, in the example of FIG. 6: (a) each of the instructions n+1 and n+2 is executable in a single machine cycle, and the instruction n is executable in two machine cycles; and (b) the instruction n+1 is dependent on its immediately preceding instruction n. However, unlike FIG. 5, in the example of FIG. 6, the instruction n+2 is likewise dependent on its immediately preceding instruction n+1. Accordingly, in FIG. 6, the system 10 executes: (a) the instruction n during its E-stage cycle k+1 and its M-stage cycle k+2; (b) the instruction n+1 during its E-stage cycle k+3; and (c) the instruction n+2 during its E-stage cycle k+4. In such a situation, the system 10 encounters a read/write conflict between the instructions n and n+1, plus a read/write dependency of the instruction n+2 on the instruction n+1. As a result, operation of the system 10 is stalled as it: (a) delays processing the E-stage of the instruction n+1 by one cycle (i.e., delayed from its originally scheduled cycle k+2 until the cycle k+3) to await the finish of the M-stage cycle k+2 of the instruction n; and (b) likewise delays processing the E-stage of the instruction n+2 by one cycle (i.e., delayed from its originally scheduled cycle k+3 until the cycle k+4) to await the finish of the E-stage cycle k+3 of the instruction n+1. In view of such delay, operation of the system 10 in FIG. 6 is not preferred.

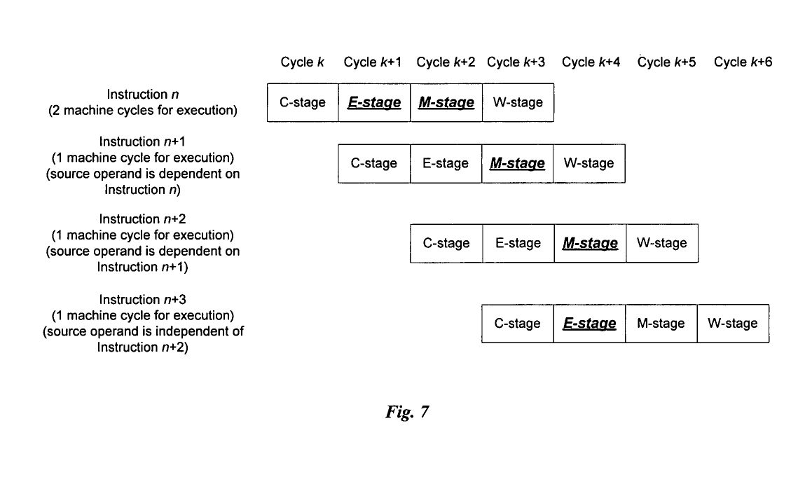

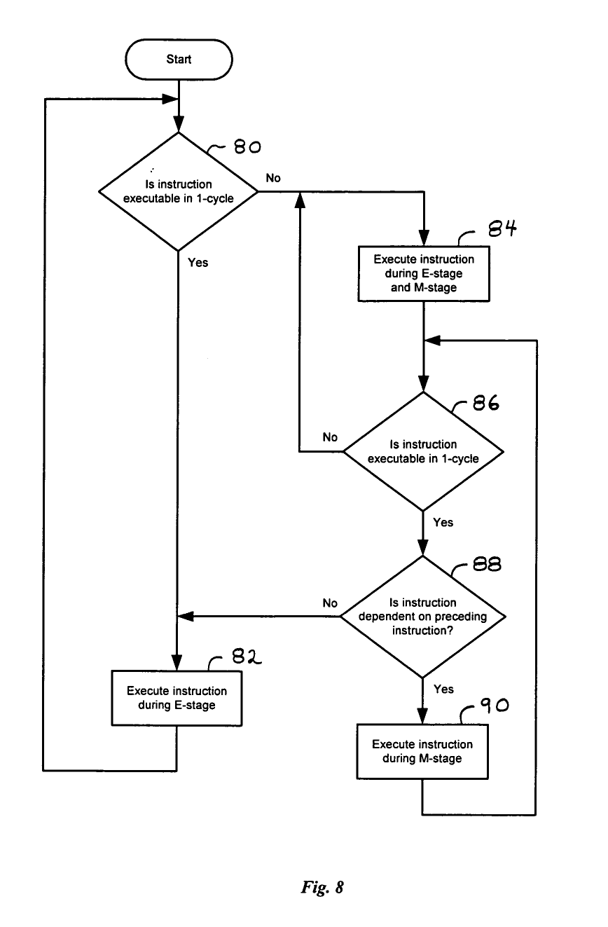

FIG. 7 is a fifth example timing diagram that depicts the instructions n, n+1, and n+2. Like FIG. 6, in the example of FIG. 7: (a) each of the instructions n+1 and n+2 is executable in a single machine cycle, and the instruction n is executable in two machine cycles; (b) the instruction n+1 is dependent on its immediately preceding instruction n; and (c) the instruction n+2 is likewise dependent on its immediately preceding instruction n+1. Moreover, the timing diagram of FIG. 7 also depicts an instruction n+3, which is: (a) executable in a single machine cycle; and (b) independent of its immediately preceding instruction n+2.

In the example of FIG. 7, the system 10 executes: (a) the instruction n during its E-stage cycle k+1 and its M-stage cycle k+2; (b) the instruction n+1 during its M-stage cycle k+3; (c) the instruction n+2 during its M-stage cycle k+4; and (d) the instruction n+3 during its E-stage cycle k+4. In such a situation, the system 10 encounters a read/write conflict between the instructions n and n+1, plus a read/write conflict between the instructions n+1 and n+2. Nevertheless, advantageously, the system 10 avoids stalling its operation. Such avoidance is achieved by: (a) executing the instruction n+1 during its M-stage cycle k+3, instead of its E-stage cycle k+2 and (b) executing the instruction n+2 during its M-stage cycle k+4, instead of its E-stage cycle k+3.

For example, by executing the instruction n+1 during its M-stage cycle k+3, the destination operand(s) of its immediately preceding instruction n are available for use (as the source operand(s) of the instruction n+1) at the start of the M-stage cycle k+3 of the instruction n+1, which coincides with the end of the M-stage cycle k+2 of the instruction n. Similarly, by executing the instruction n+2 during its M-stage cycle k+4, the destination operand(s) of its immediately preceding instruction n+1 are available for use (as the source operand(s) of the instruction n+2) at the start of the M-stage cycle k+4 of the instruction n+2, which coincides with the end of the M-stage cycle k+3 of the instruction n+1.

By comparison, for the instruction n+3 in the example of FIG. 7: (a) the system 10 does not encounter a read/write conflict between the instructions n+2 and n+3, because the instruction n+3 is independent of its immediately preceding instruction n+2; and (b) without additional delay, the system 10 processes the E-stage of the instruction n+3 during its originally scheduled cycle k+4, substantially concurrent with processing the M-stage of the instruction n+2 during the cycle k+4. During the E-stage cycle k+4 of the instruction n+3, suitable execution resources are then-currently available, because the instruction n+3 is then-currently the only instruction whose E-stage is being performed by the system 10 during the cycle k+4.

For at least certain types of instructions (e.g., certain types of instructions that have M-stage versions, as described in Table 3), the system 10 includes suitable execution circuitry (e.g., within the AAUs 22, BMU 24, ALUs 28, and/or execution unit(s) 44) for executing such an instruction during either its E-stage or M-stage, in response to (and according to) the instruction's encoding. For example, such encoding is performed either by a human programmer or by an information handling system (e.g., in the process of assembling a software program into the sequence of instructions, as discussed hereinbelow in connection with FIG. 8), so that the instruction is suitably encoded as being either an E-stage version thereof or an M-stage version thereof. If the instruction is encoded as an E-stage version thereof, the system 10 executes the instruction during its E-stage cycle. Or, if the instruction is encoded as an M-stage version thereof, the system 10 executes the instruction during its M-stage cycle. The system 10 is operable to execute the M-stage of an instruction (e.g., an instruction that is encoded as being an M-stage version thereof) substantially concurrent with (e.g., during the same machine cycle as) executing another instruction's E-stage, irrespective of whether the two instructions have the same or different types.

TABLE 3
Instructions Having One Machine Cycle for Execution in M-stage

| M-stage version of Instruction | Example Operation |
|---|---|
| & Example Assembly Syntax | (performed by the DALU 20 during M-stage) |
| M-stage version of Add | Adds two source operand registers (Da and Db) and |
| ADDM Da, Db, Dn | stores the result in a destination operand register (Dn). |
| | Does not update a carry (“C”) bit in a status register. |
| M-stage version of | Adds a first operand register (Da) to a second register |
| Add & Round | (Dn) and rounds the sum. Stores the sum in the second |
| ADRM Da, Dn | operand register (Dn). Rounding adjusts a least |
| | significant bit (“LSB”) of high portion content of the |
| | second register, according to a value of low portion |
| | content of the second register, and then clears such low |
| | portion content to a value of zero. The boundary |
| | between the high and low portions varies according to |
| | scaling. |
| M-stage version of | Subtracts a first operand register (Da) from a second |
| Subtract & Round | register (Dn) and rounds the result. Stores the result in |
| SBRM Da, Dn | the second operand register (Dn). Rounding adjusts an |
| | LSB of high portion content of the second register, |
| | according to a value of low portion content of the second |
| | register, and then clears such low portion content to a |
| | value of zero. |
| M-stage version of Subtract | Subtracts a first source operand register (Da) from a |
| SUBM Da, Db, Dn | second source operand register (Db) and stores the result |
| | in a destination operand register (Dn). Does not update |
| | the C bit in the status register. |

FIG. 8 is a flowchart of preferable operation of the system 10, in accordance with FIG. 7. Such operation is achieved by either: (a) the system 10 including suitable circuitry (e.g., the core unit 12 and execution unit(s) 44) for managing the processing of the sequence of instructions in the preferred manner of FIG. 7, so that the system 10 executes particular instructions during their M-stages instead of their E-stages at suitable locations in the sequence; or (b) using an information handling system to process assembly code for causing the information handling system to assemble a software program into the sequence of instructions, so that M-stage versions of particular instructions are selectively inserted (in place of E-stage versions thereof) at suitable locations in the sequence. With either such alternative, stalls are less likely when the system 10 processes the sequence, and FIG. 8 is discussed hereinbelow in relation to either such alternative.

The preferable operation of FIG. 8, in accordance with FIG. 7, starts at a step 80. At the step 80, the system 10 (or the information handling system that processes the assembly code) determines whether the then-current instruction is executable in a single machine cycle. If so, the operation continues to a step 82, at which the system 10 executes such instruction during its E-stage (or the information handling system that processes the assembly code inserts the E-stage version of such instruction at its location in the sequence of instructions). After the step 82, the operation returns to the step 80 for the next instruction in the sequence.

Conversely, if the system 10 (or the information handling system that processes the assembly code) determines at the step 80 that such instruction is not executable in a single machine cycle, the operation continues to a step 84. At the step 84, the system 10 executes such instruction during its E-stage and M-stage. After the step 84, the operation continues to a step 86 for the next instruction in the sequence.

At the step 86, the system 10 (or the information handling system that processes the assembly code) determines whether such instruction is executable in a single machine cycle. If not, the operation returns to the step 84. Conversely, if the system 10 (or the information handling system that processes the assembly code) determines at the step 86 that such instruction is executable in a single machine cycle, the operation continues to a step 88.

At the step 88, the system 10 (or the information handling system that processes the assembly code) determines: (a) whether such instruction is dependent on its immediately preceding instruction; and (b) whether the system 10 includes (or is specified as including) a suitable resource (e.g., execution circuitry) for executing such instruction during its M-stage. If not, the operation continues to the step 82. Conversely, if the system 10 (or the information handling system that processes the assembly code) determines at the step 88 that such instruction is dependent on its immediately preceding instruction and that the system 10 includes (or is specified as including) a suitable resource (e.g., execution circuitry) for executing such instruction during its M-stage, the operation continues to a step 90.

At the step 90, the system 10 executes such instruction during its M-stage (or the information handling system that processes the assembly code inserts the M-stage version of such instruction at its location in the sequence of instructions). After the step 90, the operation returns to the step 86 for the next instruction in the sequence.

As the system 10 performs the execution steps 82, 84 and 90 of FIG. 8, those steps are performed by suitable execution units (i.e., the AAUs 22, BMU 24, ALUs 28, and execution unit(s) 44) of the system 10. The other steps of FIG. 8 are performed by a suitable one or more of the program sequencer unit 14 (e.g., including the instruction fetch buffer 50 and sequencer logic 52), resource stall unit 16, AGU 18, DALU 20 and execution unit(s) 44 of the system 10, in communication with one another.

Although illustrative embodiments have been shown and described, a wide range of modification, change and substitution is contemplated in the foregoing disclosure and, in some instances, some features of the embodiments may be employed without a corresponding use of other features. For example, as discussed hereinabove in connection with FIG. 8, the selective insertion of an M-stage version of an instruction (at its location in the sequence of instructions) is performed by an information handling system that processes assembly code, but such insertion is likewise performable by a human programmer. Accordingly, it is appropriate that the appended claims be construed broadly and in a manner consistent with the scope of the embodiments disclosed herein.

1. A method performed by an information handling system for processing a sequence of instructions that includes first and second instructions, wherein each of the first and second instructions is processable in a sequence of stages that includes first and second execution stages, and wherein the first instruction's second execution stage is processable substantially concurrent with processing the second instruction's first execution stage, comprising:
executing the first instruction during its second execution stage; and
executing the second instruction during a selected one of its first and second execution stages.

2. The method of claim 1, wherein executing the second instruction comprises:
executing the second instruction during the selected one of its first and second execution stages, in response to an encoding of the second instruction.

3. The method of claim 1, wherein executing the second instruction comprises:
executing the second instruction during the selected one of its first and second execution stages, in response to whether the second instruction is dependent on the first instruction.

4. The method of claim 3, wherein executing the second instruction comprises:
executing the second instruction during its first execution stage in response to the second instruction being independent of the first instruction.

5. The method of claim 3, wherein executing the second instruction comprises:
executing the second instruction during its second execution stage in response to the second instruction being dependent on the first instruction.

6. The method of claim 5, wherein executing the second instruction comprises:
executing the second instruction during its second execution stage in response to the second instruction being dependent on the first instruction, but only if the system includes a suitable resource for executing such instruction during its second execution stage.

7. The method of claim 1, wherein the sequence of stages includes multiple execution stages, including the first and second execution stages and at least one additional execution stage.

8. The method of claim 7, wherein the additional execution stage precedes the first execution stage.

9. The method of claim 7, wherein the additional execution stage follows the second execution stage.

10. The method of claim 7, wherein at least one additional execution stage precedes the first execution stage, and wherein at least one additional execution stage follows the second execution stage.

11. The method of claim 1, wherein executing the first instruction comprises:
executing the first instruction during its first and second execution stages.

12. The method of claim 11, wherein the second instruction is executable in a single machine cycle of the system, and wherein the first instruction is executable in only multiple machine cycles of the system.

13. The method of claim 1, wherein the sequence of stages is processed in one machine cycle of the system per stage.

14. The method of claim 1, wherein the sequence of stages is the same for the first and second instructions.

15. A method performed by an information handling system in assembling a sequence of instructions that includes first and second instructions, wherein each of the first and second instructions is processable in a sequence of stages that includes first and second execution stages, and wherein the first instruction's second execution stage is processable substantially concurrent with processing the second instruction's first execution stage, comprising:
assembling the first instruction for execution during its second execution stage; and
assembling the second instruction for execution during a selected one of its first and second execution stages.

16. The method of claim 15, wherein assembling the second instruction comprises:
assembling the second instruction during the selected one of its first and second execution stages, in response to an encoding of the second instruction.

17. The method of claim 15, wherein assembling the second instruction comprises:
assembling the second instruction during the selected one of its first and second execution stages, in response to whether the second instruction is dependent on the first instruction.

18. The method of claim 17, wherein assembling the second instruction comprises:
assembling the second instruction for execution during its first execution stage in response to the second instruction being independent of the first instruction.

19. The method of claim 17, wherein assembling the second instruction comprises:
assembling the second instruction for execution during its second execution stage in response to the second instruction being dependent on the first instruction.

20. The method of claim 19, wherein assembling the second instruction comprises:
assembling the second instruction for execution during its second execution stage in response to the second instruction being dependent on the first instruction, but only if the system is specified as including a suitable resource for executing such instruction during its second execution stage.

21. The method of claim 15, wherein the sequence of stages includes multiple execution stages, including the first and second execution stages and at least one additional execution stage.

22. The method of claim 21, wherein the additional execution stage precedes the first execution stage.

23. The method of claim 21, wherein the additional execution stage follows the second execution stage.

24. The method of claim 21, wherein at least one additional execution stage precedes the first execution stage, and wherein at least one additional execution stage follows the second execution stage.

25. The method of claim 15, wherein assembling the first instruction comprises:
assembling the first instruction for execution during its first and second execution stages.

26. The method of claim 25, wherein the second instruction is executable in a single machine cycle of the system, and wherein the first instruction is executable in only multiple machine cycles of the system.

27. The method of claim 15, wherein the sequence of stages is processable in one machine cycle of the system per stage.

28. The method of claim 15, wherein the sequence of stages is the same for the first and second instructions.

29. An information handling system for processing a sequence of instructions that includes first and second instructions, wherein each of the first and second instructions is processable in a sequence of stages that includes first and second execution stages, and wherein the first instruction's second execution stage is processable substantially concurrent with processing the second instruction's first execution stage, comprising:
first circuitry for executing the first instruction during its second execution stage; and
second circuitry for executing the second instruction during a selected one of its first and second execution stages.

30. The system of claim 29, wherein the second circuitry is for executing the second instruction during the selected one of its first and second execution stages, in response to an encoding of the second instruction.

31. The system of claim 29, wherein the second circuitry is for executing the second instruction during the selected one of its first and second execution stages, in response to whether the second instruction is dependent on the first instruction.

32. The system of claim 31, wherein the second circuitry is for executing the second instruction during its first execution stage in response to the second instruction being independent of the first instruction.

33. The system of claim 31, wherein the second circuitry is for executing the second instruction during its second execution stage in response to the second instruction being dependent on the first instruction.

34. The system of claim 33, wherein the second circuitry is for executing the second instruction during its second execution stage in response to the second instruction being dependent on the first instruction, but only if the system includes a suitable resource for executing such instruction during its second execution stage.

35. The system of claim 29, wherein the sequence of stages includes multiple execution stages, including the first and second execution stages and at least one additional execution stage.

36. The system of claim 35, wherein the additional execution stage precedes the first execution stage.

37. The system of claim 35, wherein the additional execution stage follows the second execution stage.

38. The system of claim 35, wherein at least one additional execution stage precedes the first execution stage, and wherein at least one additional execution stage follows the second execution stage.

39. The system of claim 29, wherein the first circuitry is for executing the first instruction during its first and second execution stages.

40. The system of claim 39, wherein the second instruction is executable in a single machine cycle of the system, and wherein the first instruction is executable in only multiple machine cycles of the system.

41. The system of claim 29, wherein the sequence of stages is processed in one machine cycle of the system per stage.

42. The system of claim 29, wherein the sequence of stages is the same for the first and second instructions.

43. A computer program product, comprising:
apparatus from which a computer program is accessible by an information handling system, wherein the computer program is processable by the information handling system for causing the information handling system to assemble a sequence of instructions that includes first and second instructions, wherein each of the first and second instructions is processable in a sequence of stages that includes first and second execution stages, and wherein the first instruction's second execution stage is processable substantially concurrent with processing the second instruction's first execution stage, and wherein the assembling comprises:
assembling the first instruction for execution during its second execution stage; and
assembling the second instruction for execution during a selected one of its first and second execution stages.

44. The computer program product of claim 43, wherein assembling the second instruction comprises:
assembling the second instruction during the selected one of its first and second execution stages, in response to an encoding of the second instruction.

45. The computer program product of claim 43, wherein assembling the second instruction comprises:
assembling the second instruction during the selected one of its first and second execution stages, in response to whether the second instruction is dependent on the first instruction.

46. The computer program product claim 45, wherein assembling the second instruction comprises:
assembling the second instruction for execution during its first execution stage in response to the second instruction being independent of the first instruction.

47. The computer program product claim 45, wherein assembling the second instruction comprises:
assembling the second instruction for execution during its second execution stage in response to the second instruction being dependent on the first instruction.

48. The computer program product claim 47, wherein assembling the second instruction comprises:
assembling the second instruction for execution during its second execution stage in response to the second instruction being dependent on the first instruction, but only if the system is specified as including a suitable resource for executing such instruction during its second execution stage.

49. The computer program product of claim 43, wherein the sequence of stages includes multiple execution stages, including the first and second execution stages and at least one additional execution stage.

50. The computer program product of claim 49, wherein the additional execution stage precedes the first execution stage.

51. The computer program product of claim 49, wherein the additional execution stage follows the second execution stage.

52. The computer program product of claim 49, wherein at least one additional execution stage precedes the first execution stage, and wherein at least one additional execution stage follows the second execution stage.

53. The computer program product claim 43, wherein assembling the first instruction comprises:
assembling the first instruction for execution during its first and second execution stages.

54. The computer program product claim 53, wherein the second instruction is executable in a single machine cycle of the system, and wherein the first instruction is executable in only multiple machine cycles of the system.

55. The computer program product claim 43, wherein the sequence of stages is processable in one machine cycle of the system per stage.

56. The computer program product claim 43, wherein the sequence of stages is the same for the first and second instructions.
